(19) United States
(12) Patent Application Publication
(10) Pub. No.: US 2009/0019769 A1
(43) Pub. Date: Jan. 22, 2009

(54) Steam And Hydrogen Generator

(75) Inventors: Amnon Yogev, Rechovot (IL); Eliyahu Gamzon, Doar-Na Nahal Soreg (IL); Moran Shmuely, Rosh HaAyin (IL)

Correspondence Address: MARTIN D. MOYNIHAN d/b/a PRTSI, INC., P.O. BOX 16446, ARLINGTON, VA, 22215, US

(73) Assignee: Engineuity Research and Development Ltd, Yavne (IL)

(21) Appl. No.: 11/920,269

(22) PCT Filed: May 15, 2006
(86) PCT No.: PCT/IL2006/000570

§ 371 Date: Nov. 13, 2007

Related U.S. Application Data
(60) Provisional application No. 60/681,165, filed on May 16, 2005.

(51) Int. Cl. C01B 3/10

(52) U.S. Cl. 48/65; 423/657; 422/199

(57) ABSTRACT

Described is a method for producing hydrogen and steam in a reaction chamber, the method including: feeding a metallic contiguous element towards a discharge source; intermittently providing by the discharge source a discharge sufficient to initiate a reaction between at least a portion of the metallic contiguous element and water vapor; and continuing the reaction in absence of discharge.

### RELATED APPLICATIONS

This application claims the benefit under 35 U.S.C. 119(e) of U.S. provisional patent application No. 60/681,165, filed on May 16, 2005 entitled “Steam and Hydrogen Generator”, the disclosure of which is incorporated herein by reference.

### FIELD OF THE INVENTION

The present invention relates to a device and a method for the production of high temperature steam and hydrogen.

### BACKGROUND OF THE INVENTION

Hydrogen is expected to be the clean fuel of the future. The reasons for that is the global interest in use of oil substitutes, which are environmental friendly, as fuel sources, and the fact that the combustion of hydrogen results in water alone, whereas the combustion of fuel and coal forms CO₂, which pollutes the atmosphere, contributing to the “greenhouse” effect. However, handling and distribution of hydrogen gas is problematic due to safety problems and low density of energy content.

U.S. Pat. No. 4,702,894 to Cornish, the disclosure of which is incorporated herein by reference, described generating hydrogen by heating a metal surface under water to a temperature at which the metal reacts with water to produce hydrogen. According to this patent, the under water heating can be done electrically, with a wire carrying a voltage of about 18,000 volts under current of about 1 amp.

DT 2360568 to Studenski, the disclosure of which is incorporated herein by reference, describes a process for operation of a compression motor as a combustion vapor machine. According to this process, magnesium reacts with water in the presence of air to produce hydrogen, and the hydrogen is burned with the same air in the same chamber. It is not clear why the magnesium does not react with the air directly.

### SUMMARY OF THE INVENTION

An aspect of some embodiments of the present invention relates to a method for producing hydrogen and steam from a reaction between metal and water. The reaction is initiated by an electric discharge that ignites the metal, and continues without a need for another discharge. This allows continuous production of steam and hydrogen while requiring only intermittent electric discharge. The method relies on the finding, that when suitable amounts of water and metal are introduced into the reaction chamber the reaction continues in the absence of discharge. For this, the water should be in excess over the metal, but in amounts small enough not to cool the metal to below the reaction temperature.

In an embodiment of the invention, the method includes feeding a metallic contiguous element, such as a metal or metal-containing wire or rod, towards a discharge source; providing water vapor to the vicinity of the metallic contiguous element; intermittently providing by the discharge source a discharge sufficient to initiate a reaction between the metal and the water vapor; and continuing the reaction in absence of discharge. The longer the reaction is in absence of discharge, the less energy is spent on providing electrical discharges.

An element is considered contiguous if it has a dimension, along which the reaction can advance for at least 1 cm. It may have the form of a spiral, elongate conduit, rod, wire, or any other shape that allows the reaction to advance along a certain dimension as to exit discharge distance from the discharge electrode.

Any substance that provides hydrogen and heat upon reaction with water may be suitable as metal in accordance with the present invention. Preferred are stable substances, which do not spontaneously react with water at ambient temperature, for instance, at 300K. Non-limiting examples of such substances are Mg, Al, B, Zn, mixtures thereof and alloys thereof.

In an exemplary embodiment, a metallic element in the form of a rod or wire is fed in a continuous manner into a reaction chamber and towards a discharge electrode within the chamber. When at least a portion of the metal wire reaches a discharge distance from the discharge electrode a discharge occurs, and a reaction between the metallic element and water vapor begins. The reaction shortens the wire, and takes it off the discharge distance from the electrode. The heat produced by the exothermic reaction between metal and water suffices to keep at least a portion of the metallic element at the reaction temperature, and this way makes possible continuation of the reaction without a need for an additional discharge. In this exemplary embodiment, the continuous feeding of metal compensates for the shortening of the wire, and there is also a constant supply of water to maintain the amount of water vapor in the vicinity of the reacting portion of the metal sufficient to continue the reaction. The rate of advancement of the metal is optionally controlled to retain the reaction site within the reaction chamber but out of discharge distance from the electrode.

If the reaction stops, for instance, because the metal cools to below the reaction temperature, the continuous advancement of the metal wire will bring the metal back to discharge distance from the electrode, a discharge will occur, and the reaction will be resumed. Such an embodiment provides self-control of the system over the reaction and decreases the possibility of non-intentional stoppage of the reaction. Alternatively or additionally, the discharge source is intermittently shut on and off to provide intermittent discharge.

It is preferred to carry out the method of the invention when the reaction chamber is substantially free of liquid water. This may be achieved if the temperature inside the chamber is above the boiling temperature of water at the pressure inside the reaction chamber, or preferably, above the critical temperature of water. It is also preferred to introduce the water into the reaction chamber as droplets of liquid that evaporate inside the chamber. This way the cooling effect of the water increases, and the energy required to push the water into the reaction chamber against the working pressure inside it is smaller.

Optionally, the suitable amount of water and metal are found as follows: the metal is introduced in a constant rate, and a target temperature is set for the output hydrogen and steam. The output temperature is measured, and the input rate of water is increased if the measured temperature is above the target temperature, or decreased, if the measured temperature is below the target temperature. When the proper input rate of water is found, the discharge source can be shut off, and the reaction will ideally continue flawlessly. In practice, fluctuations might occur, for instance due to irregularity in the metal rod, and if a fluctuation brings the reaction to stop, the reaction is restarted next time the end of the rod reaches discharge distance from the electrode. The movement that provides additional metal into the chamber is preferably the same as the movement that bring the metal to discharge distance from the electrode.

An aspect of some embodiments of the invention is a device carrying out a method as described above. The device includes a reaction chamber having therein water vapor, a metallic contiguous element, and a discharge system. The discharge system is configured to provide an electric discharge sufficient to ignite the metal, such that the metal reacts with water vapor. The metal in the device is continuously moving towards the discharge electrode, and the discharge system provides a discharge only intermittently. The term intermittently is used herein to denote the system provides a discharge only a portion of the time, and in a manner, which may be regular, although many times is not. In some embodiments, the discharge occurs only when needed in order to start the reaction, either in the beginning of operation, or when the reaction stops during operation of the device.

The moving velocity of the metal towards the discharge electrode is preferably lower than or equal to the reaction velocity. In this context, the reaction velocity is the velocity in which the metallic element shortens. When advancement velocity is below reaction velocity it may happen that the reaction stops, and for some time, until another discharge occurs, there is no reaction in the chamber, and the device outlets steam and hydrogen produced before the reaction stopped. This way, control of the advancement velocity provides control over the pressure and the temperature inside the reaction chamber.

In an embodiment of the invention, the device allows introducing into the reaction chamber more than one metallic contiguous element, optionally through a plurality of feeding systems, each feeding one element. The elements may be of similar or different shape and size, and may be fed simultaneously or not. Such an arrangement may be used for providing a hydrogen-generating device with a wide range of power output. For instance, a thick element may be used to provide higher input than provided by a thinner element. Alternatively or additionally, a plurality of elements fed simultaneously provide higher power output than provided by each one of the on its own.

The device of the invention can be used as a stand-alone system for the supplying of steam and hydrogen, or otherwise, it can be integrated on board of an engine, adapted to use hydrogen as fuel and to utilize pressurized high temperature steam. When used with an engine, the amount of metal introduced into the reaction chamber may be utilized to control the power output of the engine. This engine may be a turbine, an internal combustion engine, a steam engine or any other power conversion system.

Accordingly, an aspect of some embodiments of the invention relates to a method for producing hydrogen and steam in a reaction chamber, the method comprising: feeding a metallic contiguous element towards a discharge source; intermittently providing by the discharge source a discharge sufficient to initiate a reaction between at least a portion of the metallic contiguous element and water vapor; and continuing the reaction in absence of discharge.

Optionally, the feeding is continuous.

Optionally, the contiguous element is a rod or a wire.

Optionally, continuing the reaction in absence of discharge comprises continuing for at least one second. Optionally, the method is carried out along a period of time, and the discharge source is active less than half of said period of time.

According to an embodiment of the invention, the discharge is provided when the metallic contiguous element is at discharge distance form a discharge source, and the reaction shortens the metallic contiguous element, thereby taking it out of discharge distance from the discharge source. Optionally, the feeding does not bring the rod or wire to discharge distance from the distance source as long as the reaction continues.

In an embodiment of the invention, the method further comprising stopping the reaction; and renewing the reaction by the continuous feeding. Optionally, stopping the reaction comprises cooling the metal to below the reaction temperature. Optionally, cooling comprises providing water in amounts sufficient to cool the metal to below the reaction temperature.

In an embodiment of the invention, continuing the reaction comprises providing into the reaction chamber water such that the water inside the reaction chamber is in excess over the metal. Optionally, continuing the reaction comprises providing into the reaction chamber water in amounts small enough to maintain the temperature in the reaction chamber above the boiling temperature of water inside the reaction chamber, or above the critical temperature of water.

Optionally, the reaction chamber is substantially free of oxygen. Optionally, the method comprising letting the hydrogen out of the reaction chamber at an outlet temperature above 200° C., or above 300° C.

Optionally, the method comprises monitoring the temperature of the produced hydrogen and steam and providing water and/or metal in a rate(s) responsive to the monitored temperature.

Optionally, the method includes providing water droplets into the reaction chamber and evaporating the water droplets. Optionally, the heat of the reaction evaporates the water droplets.

Preferably, the metal in the metallic contiguous member is a stable metal, which does not spontaneously react with water at 30° C. Optionally, the stable metal is selected from the group consisting of Mg, Al, B, Zn, mixtures thereof and metal alloys thereof. Optionally, the method is carried out on board of a moving vehicle. Alternatively, the method is carried out in a stationary device. Optionally, the engine is selected from the group consisting of a turbine, an internal combustion engine and a steam engine.

Optionally, the velocity in which metal is introduced into the reaction chamber controls the power output.

Optionally, the method includes separating the produced steam from the produced hydrogen, optionally by a membrane, and using them separately. Optionally, the membrane comprises a metal membrane.

In an embodiment of the invention, the hydrogen is used in a fuel cell and the steam is used in a steam engine. Alternatively or additionally, the hydrogen and the steam are used as a mixture in a steam engine without ignition of the hydrogen, and after expansion in the engine the steam is partly condensed and the hydrogen is separated.

An aspect of some embodiments of the invention relates to a device for the production of hydrogen and steam by a reaction between metal and water vapor, the device comprising:
a. a reaction chamber equipped with a discharge electrode;
b. a water inlet for introducing water into the reaction chamber;
c. a power-source connected to the discharge electrode and connectable to a metallic contiguous member, such that when the metal rod or wire reaches the discharge electrode a discharge occurs, said discharge being sufficient to ignite the metal;
d. a metal feeding system configured for advancing the metallic contiguous element towards the discharge electrode;
e. a gas outlet for outletting steam and hydrogen from the reaction chamber; and
f. a control system configured to control the metal feeding system and water inlet, such that: (i) the device outlets steam and hydrogen at temperatures around a target temperature, which is optionally above 100° C., optionally above 300° C.; (ii) the temperature inside the reaction chamber is above a the boiling temperature of water at the pressure inside the reaction chamber; and (iii) the discharge electrode operates intermittently.

Optionally, the contiguous metallic member is a metal rod or wire.

Optionally, a device according to the invention comprises a plurality of metal feeding systems, which together are capable of feeding a plurality of metal wires or rods into the reaction chamber.

Optionally, the device has feeding system comprising elastic seals for feeding the metallic contiguous element into the reaction chamber without releasing hydrogen and steam from the reaction chamber to the environment.

Optionally, the water inlet introduces into the reaction chamber water droplets.

An aspect of the present invention relates to a device for the production of hydrogen and steam by a reaction between metal and water vapor, the device comprising a reaction chamber having therein a metallic contiguous element and a discharge system configured to provide an electric discharge sufficient to ignite at least a portion of the metallic contiguous element, and at least a portion of the metal reacts with water vapor while the metal element continuously moves towards the discharge electrode, and the discharge system provides discharge intermittently. Optionally, the temperature inside the reaction chamber is above the boiling temperature of water at the pressure inside the device. Preferably, the temperature inside the reaction chamber is above the critical temperature of water.

Optionally, the device comprises a plurality of metallic contiguous elements, entering the reaction chamber. Optionally, the discharge electrode is connected to a voltage source of less than 100V. Optionally, in a device according to the invention, the metal enters the reaction chamber through elastic seals. Optionally, the device includes an isolating member for isolating a portion of the metallic contiguous element from the water. Optionally, the device includes thermal insulation for thermally insulating a portion of the metallic contiguous element from the reaction chamber. Optionally, the device includes heat exchanger for cooling said portion of the metallic contiguous element. Optionally the device further includes a membrane, optionally a metal membrane, for separating the hydrogen from the steam.

### BRIEF DESCRIPTION OF THE FIGURES

Exemplary non-limiting embodiments of the invention will be described in conjunction with the figures.

FIG. 1 schematically illustrates one embodiment of a device for producing hydrogen and steam according to the invention;

FIG. 2 schematically illustrates a steam and hydrogen producing device with a hybrid consumer according to one embodiment of the invention; and

FIG. 3 schematically illustrates a steam and hydrogen consuming device on board of a car engine.

Dimensions of components and features shown in the figure are chosen for convenience and clarity of presentation and are not necessarily shown to scale.

### DETAILED DESCRIPTION OF EMBODIMENTS OF THE INVENTION

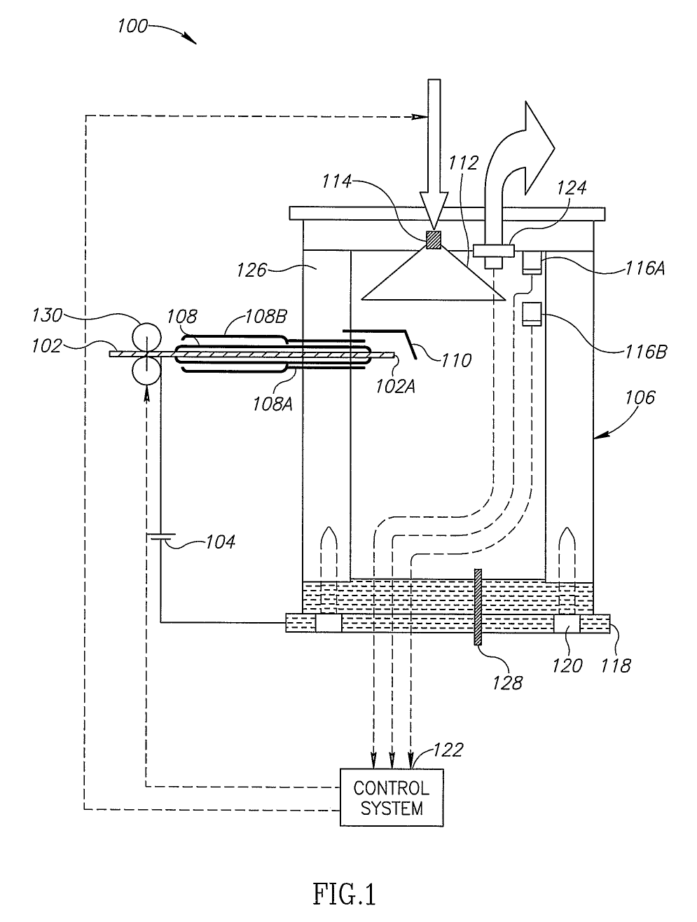

FIG. 1 schematically illustrates a device (100) according to one embodiment of the invention. In this embodiment, a metal wire or rod (102), connected to an electric power source (104), is forced into a reaction chamber (106), which is preferably sealed. The wire or rod (102) is advanced towards a counter electrode (110, also referred to as a “discharge electrode”), initially insulated from the metal wire or rod, and electrically connected to the power source (104) through the walls (126) of the chamber (106). Alternatively, the discharge electrode may be connected to the power source with a wire (not shown), which is optionally electrically insulated from the walls of the chamber.

FIG. 1 also shows an optional feeding mechanism (130) that pushes the metal wire or rod (102) into the reaction chamber (106) along a horizontal line towards the discharge electrode (110). In other embodiments, the rod or wire (102) enters the chamber (106) vertically, or in other angles to earth.

The discharge electrode (110) is optionally rod-like and shaped as a hockey-stick, as shown in the figure. In other embodiment, the discharge electrode may have any other shape known in the art, for instance, mesh, disc, drum, or straight. The angle at which electrode (110) is drawn in FIG. 1 to receive the rod (102) may have an advantage in that when the metal rod bounces into it without discharge (for instance, because the discharge power source is disconnected from the electrode), the metal rod may bend, rather than clash with the electrode. Alternatively or additionally, the electrode may be resiliently attached to the inner wall of the chamber, such that the electrode bends if hit by an advancing metal rod. Additionally or alternatively, the electrode may be formed with an aperture allowing an advancing rod to go therethrough without clashing.

Also shown in FIG. 1 are elastic seals (108), for feeding the metal rod into the chamber without releasing gas from the chamber to the environment. Any other means that are capable of advancing the metal into the chamber without letting gas out may replace the elastic seals. A non-limiting example of which is a hot-nozzle. Additionally, seals (108) may serve as an insulating member, insulating the portion of the wire inside them from water vapor inside the chamber. Seals (108) are optionally provided in a ceramic sleeve (108A) that thermally isolates the seals from the walls (126) of the chamber, which in operation may be considerably heated by heat originating in the reaction chamber. A heat exchanger (108B) is optionally used for cooling a portion the metal wire (102) outside the chamber (106).

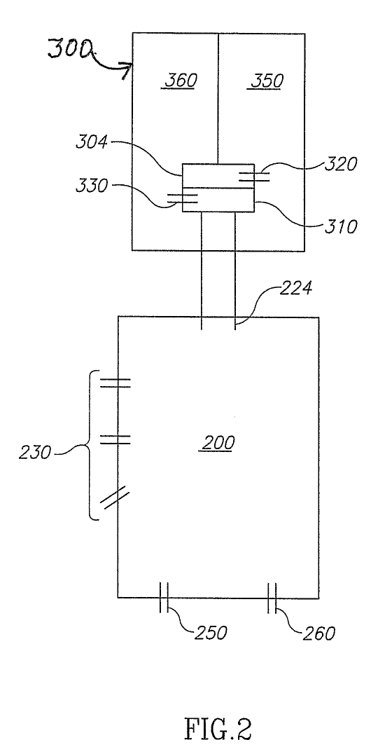

Also shown in the figure are a water inlet (114), water inserted there through (112), a gas outlet (124), for letting the produced hydrogen and steam out of the device (100) for use by any consuming system (300 in FIG. 2), and a safety outlet (128) configured to allow relief of pressure when the pressure rises to above a predetermined value.

The reaction chamber of this embodiment (106) is further equipped with optional temperature sensor (116A), pressure sensor (116B), and removable cover (118). The optional removable cover is sealed to the chamber walls with screws (120). The removable cover (118) may be removed to open the chamber for cleaning, inspection, maintenance, and the like. A control system (122) controls the power output by controlling the rate of introduction of the metal (102) and/or water (112) into the chamber (106). The control system (122) optionally also controls the gas outlet (124), and through it the pressure inside the chamber. Additionally or alternatively, the gas outlet is controlled by the consumer that receives the hydrogen and steam going out from the outlet (124). In an exemplary embodiment, the consumer communicates with the device through the control system.

In operation the metal (102) is advanced towards the electrode (110) by the feeding mechanism (130) against the pressure inside the reaction chamber (106). The advanced metal reaches a discharge distance from the electrode, and this produces an electrical discharge, which heats the metal (102) and the atmosphere inside the reaction chamber (106) to initiate reaction with water vapor.

Water for the reaction (112) is injected into the chamber (106) via the sprinkler (114) as small droplets. The sprinkler (114) is configured to sprinkle water against the pressure inside the reaction chamber. Water is optionally injected at different times than metal is fed in, and is optionally controlled in a control loop different than, and optionally independent from the control loop of metal advancement. In some embodiments, the water has its own control loop. The pressure in the chamber is preferably lower than the vapor pressure of water in the temperature inside the chamber, and the water (112) evaporates before it reaches the metal (102). If liquid water does reach the hot metal, the metal is considerably cooled due to the water's high heat of evaporation, and the reaction might stop or slow down. The water vapor reacts with the metal, and the metal rod (102) contracts accordingly, and this way the end (102A) of the rod gets out of discharge distance from the electrode (110). Alternatively or additionally, the rod (102) may be retracted by the feeding mechanism (130).

The metal rod continues to advance towards the electrode (110) and continues to react with the water (112). Optionally, the advancement velocity of the metal rod and the flow of water injected through the sprinkler (114) are adjusted by the control system (122) such that the distance between the metal wire (102) and the electrode (110) is relatively constant, namely, the end (102A) of the rod (102) does not get into the seals (108), and does not get to discharge distance from the electrode. The heat produced by the reaction between the metal and the water sustains the reaction, and the water flow through the sprinkler (114) controls the temperature inside the chamber (106): the larger the water excess is over the metal, the lower is the temperature.

Metal oxide, which is a by-product of the reaction between water and metal, may be discarded from the device (100) by any means known in the art, as described, for instance, in US Patent Application Publication No. 2004/0237499.

If the water reacts with magnesium, and there is no excess of water, it is expected that the temperature will rise to around 1500° C., which usually is not desirable. In order to maintain temperature of between about 300 to about 600° C., the molar ratio between water and magnesium should be between about 3:1 and about 6:1. With other metals these numbers differ.

The control system (122) is preferably configured to control the temperature independently of the pressure. Pressure control may be obtained by controlling the rate in which metal is introduced into the chamber, and/or by controlling the rate in which hydrogen and steam are evacuated from the system through the outlet (124).

Increasing the metal introduction rate is optionally obtained by increasing the advancement rate of the metal towards the electrode. Additionally or alternatively, metal may be introduced in more than one rod, such that when higher pressure (or power output) is required, additional rods are introduced into the chamber, optionally via additional feeding systems (not shown). Optionally, different metal rods advance towards different discharge electrodes that may be connected to the same or to different power sources. Additionally or alternatively, different metal rods advance towards a common discharge electrode. Temperature control may be obtained by adjusting the ratio between the water and the metal introduced into the system. The more water added per metal unit, the lower is the temperature, as there is more material in the system to absorb the heat of the reaction.

Optionally, the control system (122) controls the advancement of the metal rod or wire (102) such that electric discharge takes place only a portion of the time, for instance 90%, 70%, 50%, 30%, 10%, 5%, 1%, or any lower or intermediate value. It is also optional, that the control system controls the advancement of the metal wire or rod such that between one electric discharge and another, a period of at least 1 second, 5, seconds, 30 seconds, or any other higher or intermediate period will lapse. This period may be changed during operation of the system, and is optionally directly definable by an operator of the apparatus, but is not necessarily so. For instance, the operator may define an output temperature and pressure to the control system, and the control system would control the advancement of the metal wire or rod, the water injection, and the outlet of fluid from the chamber in a way that maintains the predefined parameters. In an embodiment of the invention such control brings the electric discharge to occur only a portion of the time or only some period after a preceding discharge, as explained above.

The electrode (110) is connected to an electrical power source (104), for providing the electrical discharge. The voltage required to ignite a magnesium rod under water vapor was found to be less than 100V, and in many cases voltage of between about 10 and about 30V is sufficient. If, during operation of the system, an arc is created, the electrical discharge current grows irregularly, in which case the control system (122) optionally disconnects the discharge power source (104), for safety reasons, and to facilitate further control of the pressure and temperature inside the reaction chamber.

### Example 1

A device was built in accordance with the embodiment described in FIG. 1. A magnesium wire having a diameter of 2.4 mm was fed into the system at a rate of 3.7 cm/sec. Water was injected through a sprinkler in a rate required to keep the temperature at a target temperature of 350° C. The discharge electrode was made of steal, and the discharge power source was taken from a commercially available welding machine. Voltage of about 20V at discharge was used. The control system was set to maintain a constant outflow of hydrogen and steam in total pressure of 20 atmospheres and temperature of 350° C. The safety valve was tuned to open when pressure reached 30 atmospheres. The device was operated for three minutes, and then the discharge power source was disconnected from the system, and the operation continued for three additional minutes, after which the system was shut off by stopping the advancement of the metal, and adding water, until outlet pressure started decreasing.

### Example 2

A device as used in Example 1 was operated to output steam and hydrogen in various temperatures of up to 554° C. and average temperature of 440° C. The pressure was between 12 to 22 atmospheres, with the average at 20 atmospheres. The temperature and pressure were manipulated by continuously supplying a metal wire, 2.4 mm in diameter, at an average rate of 3.4 cm/sec, and changing the water input, increasing it to decrease the temperature and decreasing it to increase the temperature. Then, water and metal input were stabilized, and the discharge power source disconnected. Operation continued for another one minute, and the system shut off as described above.

Rough Evaluation of the System's Efficacy

In the system used in examples 1 and 2, the discharge took about 1 kW electrical power (about 20V at 50 A), and the system produced about 10 kW heat power. At conversion rate of 20%-50%, which is typical to conversion from heat to electricity, this could have provided 2-5 kW of electric power. Accordingly, if constant discharge was required, 20%-50% of the energy would have been spent on discharging. However, as in the present application the discharge is intermittent, the ratio between discharge energy and output energy is much smaller. For instance, when the system operated for three minutes with the discharge circuit connected, and then another three minutes with the discharge circuit disconnected, at least 50% of the power that was above-calculated to be spent on discharge was saved. However, this figure under-evaluates the achieved saving, since when the discharge circuit was connected, current went through it intermittently, and each time to fragments of seconds only. When the operation at constant conditions is much longer than the time required for stabilizing the system at the constant conditions, the required discharge energy is negligible in comparison to the energy produced.

FIG. 2 describes a device (200) according to an embodiment of the present invention, on board of a consumer (300).

The device (200) is shown to include an outlet (224) for letting steam and hydrogen into the consumer (300). The device 200 is also shown to have two optional outlets (250) and (260). Outlet (250) is optionally used for letting water out of the device (200) after it has stopped operation, and before re-operating it. Outlet (260) is optionally used to let out metal oxide produced by the reaction between water and metal. Other elements of the device 200 are similar to those shown in device 100 of FIG. 1, and for simplicity are not reproduced on FIG. 2.

In the embodiment of FIG. 2, device (200) is adopted for a hybrid operation on both a thermal machine and an electric power and used in a fuel cell (350), while the steam is used in a steam engine (360). The hydrogen and the steam may also be used, separately, in other heat and power combined systems, the consumer 300 is shown to include a separation unit (304) for separating hydrogen from steam. The separation unit (304) includes a separating membrane (310), which is optionally a metallic membrane, which separates hydrogen from steam. The separation unit (304) has a hydrogen outlet (320) at one side of the membrane (310), and a steam outlet (330) at the other side of the membrane.

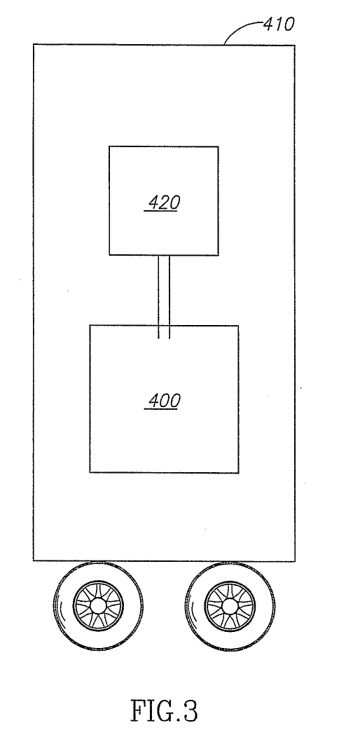

In FIG. 3, a device (400) according to an embodiment of the invention is on board of a car (410), providing steam and energy to the car's engine (420).

In another embodiment, a device for producing steam and hydrogen provides steam and hydrogen at high temperature and pressure into a steam engine, which does not ignite the hydrogen, and after expansion in the engine the steam is partially condensed in a condenser and the hydrogen is separated and can be used for other applications such as a fuel cell.

Finally, Applicants' earlier application, published as US 2004/0237499, the disclosure of which is incorporated herein by reference, describes many other combinations of consumers with a reaction chamber that produces steam and hydrogen, and in all these combinations the reaction chamber may be according to embodiments of the present invention.

A device and method as described above may also be used for oxidizing a metal with carbon dioxide to produce carbon monoxide. For this, the water inlet (114) is replaced with CO₂ inlet, and the output going out through outlet (124) is CO. A similar device and method may also be used for producing steam and syngas (a gaseous mixture of hydrogen and carbon monoxide). For this, carbon dioxide and water are reacted with the metal. For the implementation of the method and device for syngas production, the device of FIG. 1 is optionally amended by adding to the water inlet (114) a CO₂ inlet.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the disclosure and/or claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims.

1. A method for producing hydrogen and steam in a reaction chamber, the method comprising:
a. feeding a metallic contiguous element towards a discharge source;
b. intermittently providing by the discharge source a discharge sufficient to initiate a reaction between at least a portion of the metallic contiguous element and water vapor; and
c. continuing the reaction in absence of discharge.

2. A method according to claim 1, wherein said feeding is continuous.

3. A method according to claim 1, wherein the contiguous element is a rod or a wire.

4. A method according to claim 3, wherein discharge is provided when the metallic contiguous member is at discharge distance from a discharge source, and the reaction shortens the metallic contiguous member, thereby taking it out of discharge distance from the discharge source.

5. A method according to claim 4, wherein the feeding does not bring the rod or wire to discharge distance from the distance source as long as the reaction continues.

6. A method according to claim 1, wherein the method further comprising:
c. stopping the reaction; and
d. renewing the reaction by the continuous feeding.

7. A method according to claim 6, wherein stopping the reaction comprises cooling the metal to below the reaction temperature.

8. A method according to claim 7, wherein said cooling comprises providing water in amounts sufficient to cool the metal to below the reaction temperature.

9. A method according to claim 1, wherein continuing the reaction in absence of discharge comprises continuing for at least one second.

10. A method according to claim 1, wherein continuing the reaction comprises providing into the reaction chamber water such that the water inside the reaction chamber is in excess over the metal.

11. A method according to claim 1, wherein continuing the reaction comprises providing into the reaction chamber water in amounts small enough to maintain the temperature in the reaction chamber above the boiling temperature of water inside the reaction chamber.

12. A method according to claim 11, wherein the temperature in the reaction chamber is above the critical temperature of water.

13. A method according to claim 1, wherein the reaction chamber is substantially free of oxygen.

14. A method according to claim 1, comprising letting the hydrogen out of the reaction chamber at an outlet temperature above 200° C.

15. A method according to claim 14, wherein the outlet temperature is above 300° C.

16. A method according to claim 1, carried out along a period of time, wherein the discharge source is active less than half of said period of time.

17. A method according to claim 1, comprising monitoring the temperature of the produced hydrogen and steam and providing water in a rate responsive to the monitored temperature.

18. A method according to claim 1, comprising monitoring the temperature of the produced hydrogen and steam and providing metal in a rate responsive to the monitored temperature.

19. A method according to claim 8, wherein providing water comprises providing water droplets into the reaction chamber and evaporating the water droplets.

20. A method according to claim 1, wherein the metal is a stable metal, which does not spontaneously react with water at 30° C.

21. A method according to claim 20, wherein the stable metal is selected from the group consisting of Mg, Al, B, Zn, mixtures thereof and metal alloys thereof.

22. A method according to claim 1, carried out on board of a moving vehicle.

23. A method according to claim 22, wherein said engine is selected from the group consisting of a turbine, an internal combustion engine and a steam engine.

24. A method according to claim 1, wherein the velocity in which metal is introduced into the reaction chamber controls the power output.

25. A method according to claim 1, comprising separating the produced steam from the produced hydrogen and using them separately.

26. A method according to claim 25, wherein separating comprises filtering through a membrane.

27. A method according to claim 26, wherein the membrane comprises a metal membrane.

28. A method according to claim 25, wherein the hydrogen is used in a fuel cell and the steam is used in a steam engine.

29. A method according to claim 1, wherein the hydrogen and the steam are used as a mixture in a steam engine without ignition of the hydrogen, and after expansion in the engine the steam is partly condensed and the hydrogen is separated.

30. A device for the production of hydrogen and steam by a reaction between metal and water vapor, the device comprising:
a. a reaction chamber equipped with a discharge electrode;
b. a water inlet for introducing water into the reaction chamber;
c. a power-source connected to the discharge electrode and connectable to a metallic contiguous member, such that when the metal rod or wire reaches the discharge electrode a discharge occurs, said discharge being sufficient to ignite the metal;
d. a metal feeding system configured for advancing the metallic contiguous element towards the discharge electrode;
e. a gas outlet for outletting steam and hydrogen from the reaction chamber; and
f. a control system configured to control the metal feeding system and water inlet, such that: (i) the device outlets steam and hydrogen at temperatures around a target temperature; (ii) the temperature inside the reaction chamber is above the boiling temperature of water at the pressure inside the reaction chamber; and (iii) the discharge electrode operates intermittently.

31. A device according to claim 30, wherein the contiguous metallic member is a metal rod or wire.

32. A device according to claim 30, wherein the target temperature is above 100° C.

33. A device according to claim 30, wherein the target temperature is above 300° C.

34. A device according to claim 30, comprising a plurality of metal feeding systems, which together are capable of feeding a plurality of metal wires or rods into the reaction chamber.

35. A device according to claim 30, wherein said feeding system comprises elastic seals for feeding the metallic contiguous element into the reaction chamber without releasing hydrogen and steam from the reaction chamber to the environment.

36. A device according to claim 30, wherein the water inlet introduces into the reaction chamber water droplets.

37. A device for the production of hydrogen and steam by a reaction between metal and water vapor, the device comprising a reaction chamber having therein a metallic contiguous element and a discharge system configured to provide an electric discharge sufficient to ignite at least a portion of the metallic contiguous element, and at least a portion of the metal reacts with water vapor while the metal element continuously moves towards the discharge electrode, and the discharge system provides discharge intermittently.

38. A device according to claim 37, wherein the temperature inside the reaction chamber is above the boiling temperature of water at the pressure inside the device.

39. A device according to claim 37, wherein the temperature inside the reaction chamber is above the critical temperature of water.

40. A device according to claim 37, comprising a plurality of metallic contiguous members, entering the reaction chamber.

41. A device according to claim 37, wherein the discharge electrode is connected to a voltage source of less than 100 V.

42. A device according to claim 37, wherein the metal enters the reaction chamber through elastic seals.

43. A device according to claim 37, comprising an isolating member for isolating a portion of the metallic contiguous element from the water.

44. A device according to claim 37, comprising thermal insulation for thermally insulating a portion of the metallic contiguous element from the reaction chamber.

45. A device according to claim 44, comprising a heat exchanger for cooling said portion of the metallic contiguous element.

46. A device according to claim 37, further comprising a membrane for separating the hydrogen from the steam.

47. A device according to claim 46, wherein the membrane is a metal membrane.
